(19) United States
(12) Patent Application Publication
(10) Pub. No.: US 2013/0154394 A1
(43) Pub. Date: Jun. 20, 2013

(54) METHOD AND DEVICE FOR CONTROLLING AN ELECTRIC CURRENT GENERATION OF A SUBMODULE IN A PHOTOVOLTAIC SYSTEM

(71) Applicants: Tobias Mildenstein, Erfurt (DE); Karsten Funk, Weimar (DE)

(72) Inventors: Tobias Mildenstein, Erfurt (DE); Karsten Funk, Weimar (DE)

(21) Appl. No.: 13/702,960

(22) PCT Filed: Apr. 15, 2011
(86) PCT No.: PCT/EP2011/055983

§ 371 Date: Feb. 28, 2013

(30) Foreign Application Priority Data
Jun. 8, 2010 (DE) 102010029813.1

(51) Int. Cl. G05F 1/46

(52) U.S. Cl. CPC G05F 1/46
USPC 307/131

(57) ABSTRACT

A method for controlling current generation in a photovoltaic system having at least one submodule connected to the photovoltaic system. The method includes an alternating switching of the submodule taking place in a changeover time clock pulse between a switching-on state and a bypass switching state, the submodule being interconnected during the switching-on state of the photovoltaic system and being bridged in the bypass switching state. During the bypass switching state, an overall current strength of the photovoltaic system is measured and a setpoint value ascertained from this is stored temporarily. During the switching-on state, a submodule current strength is measured and compared to the setpoint value, and upon a dropping off of the submodule current strength below the setpoint value, a resetting, taking place independently of the switchover time clock pulse, of the submodule to the bypass switching state is carried out.

### FIELD

The present invention relates to a method and device for controlling electric current generation of a submodule in a photovoltaic system.

### BACKGROUND INFORMATION

Conventional solar modules are often made up of a plurality of individual solar cells, which are, in turn, combined to form a series of submodules. These submodules are frequently also designated as substrings. Functionally, these represent the smallest energy-generating unit of the solar module. For connecting the substrings, a connection box is conventionally used. This component produces the connection of the solar cells connected within the substrings both among one another as well as to the other modules and/or to an inverter. The connection box usually includes a circuit fit in between the metallic connectors of the substrings made of so-called bypass diodes. These bypass diodes bridge the substring in the case in which the solar current generated in the entire solar module is greater than in the respective substring. This case usually occurs when the substring becomes shadowed, as is the case, for example, because of deposited dirt, leaves blown on or time-of-day dependent shadows of neighboring objects, especially those caused by chimneys. In the shadowed case, the bypass diode associated with the respective substring becomes conductive, whereby the substring is bridged, and thus no longer contributes to the current generation. For this reason, precaution is taken against a current limitation due to the shadowed cells, however, the solar energy minimally generated in the substring thereby remains unutilized, and with that, the solar module altogether does not bring in the power that actually could be generated.

### SUMMARY

According to the present invention, an example method and device are provided for controlling the electric current generation in a photovoltaic system having at least one submodule connected into the photovoltaic system.

The example method includes the following steps:

An alternating switching of the submodule is carried out, taking place in a switchover time clock pulse, between a switching-on state and a bypass switching state. In this context, the submodule is connected into the photovoltaic system in the switching-on state and contributes to the solar current generation, while it is bridged in the bypass switching state.

During the bypass switching state, an overall current strength of the photovoltaic system is measured and stored temporarily as a setpoint value. During the switching-on state, a submodule current strength is measured and compared to the setpoint value. In response to a drop in the submodule current strength below the setpoint value, a resetting taking place independently of the switchover time clock pulse is carried out of the submodule into the bypass switching state.

The method sequence is accordingly characterized by two switchover processes. During the first switchover process, which is carried out using a switchover-time clock pulse that is fixed, first of all, the submodule is alternatingly transposed into a first switching state, in time intervals that are fixed at first, in response to which it is switched into the photovoltaic system. In a second switching state, following in a fixed switchover time clock pulse, the submodule is bridged and is therefore separated by switching technology from the unit of the photovoltaic system. During the time interval of the bridging, a current strength is measured that is possible in the overall system for unshadowed solar modules. This current strength is used as a setpoint value which is stored temporarily. After switchover into the on-switched state, the current strength provided by the submodule is then measured as the submodule current strength and is compared to the setpoint value ascertained before.

This first switchover process thus generates a scanning and comparative procedure in which, for one thing, the current strength of the overall system is measured overall, and for another, the current strength of the submodule is measured, and the two values are continuously alternatingly compared to each other. The time interval for the bypass switching state may be small compared to the time interval in which the submodule is in the switching-on state.

In addition, the first switchover process is joined by a second switchover process. The latter is designated as the resetting of the submodule. In it, the submodule is reset into the bypass switching state when the current strength of the submodule drops below the value of the setpoint value. Thereby the submodule, that is operating temporarily in a power-reduced manner, is released by switching technology from the unit of the photovoltaic system. During the carrying out of the second switchover process, however, the first switchover process continues to run. This means that, for one thing, continuously new setpoint values are being ascertained and, for another, the second switchover process is lifted if, during the course of the first switchover process, the submodule is shifted back into the switching-on state.

Thereby one may achieve a method-technological unit from the setting of a setpoint value, a setpoint/actual comparison and an alignment between the power implemented by the submodule and the power produced in the entire photovoltaic system, and consequently a power adjustment between the part of the photovoltaic system and the submodule.

In one expedient specific embodiment, the resetting is performed at a switching time which is a function of a variable of a deviation between the setpoint value and the submodule current strength. By using this design, it is taken into account that small deviations between the actual value and the setpoint value of the current of the submodule frequently only occur briefly and in passing, so that resetting the submodule into the bypass switching state is not necessarily required. The resetting is omitted if the deviation has already disappeared again before the switching time.

The switching time of the resetting is influenced in one expedient specific embodiment by the discharge behavior of a capacitor connected to the submodule. Smaller deviations lead to slower discharges, larger ones to more rapid discharges of the capacitor, and accordingly to later or earlier switching times.

In a further specific embodiment, the switchover time clock pulse itself is made variable. In particular, it has a value that is a function of the submodule current strength. The switchover time clock pulse, in this instance, or rather the switching frequency, or synonymously with that, the number of switchover pulses per time unit, grows with decreasing submodule current strength.

This specific embodiment takes into account, for one thing, the circumstance that a submodule, which supplies a constant strength of submodule current, has to be set less often into the bypass switching state than a submodule in which the submodule strength is comparatively low or is changing. In the first case, a change in the switching state tends to be disadvantageous, because the constantly operating submodule would have to be separated, and in the second case it is advantageous, because the submodule is reconnected again relatively rapidly after bridging, to the switching unit of the photovoltaic system.

The switchover time clock pulse may be designed to be external, and able to be set in any manner via an interface. This particularly affects a required setting of the submodule to the bypass switching state for maintenance and repair purposes, or in the case of danger or fire.

For this, the interface for forced control may be connected to a communications unit, which in the danger and/or maintenance case transfers the at least one submodule into the bypass switching state.

Furthermore, as an additional embodiment, it may be provided that the at least one submodule for transport via the interface to the forced control is able to be reset into the bypass switching state. Because of this transport assurance it is made possible to install the submodule safely in a defined state at the mounting location and put it in operation.

In accordance with the present invention, for controlling the energy production in a photovoltaic system having at least one submodule connected into the photovoltaic system, a control circuit is provided having a first current measuring device for measuring the strength of a current generated by the submodule, a second current measuring device for measuring the strength of a current generated in the photovoltaic system, a change-over switch for setting the submodule to an on-switching or a bypass switching state and a timer unit setting the change-over switch, or another reference variable.

The submodule expediently has a capacitor connected in parallel. In one specific embodiment, the timer unit, or another reference variable influencing the reset pulse, has a timer capacitor fed by the submodule and/or the photovoltaic system. Thereby, the time pulse of the timer unit is able to be derived directly from the operating state of the submodule and/or of the photovoltaic system, and determined by these.

In one specific embodiment, as the current measuring device, a system is provided of a switching transistor that is situated in a measuring shunt, or the path resistance of a transistor itself may be used as a shunt. The control circuit expediently has an interface for carrying out a forced switching of the submodule to a switching-on state or a bypass switching state.

### BRIEF DESCRIPTION OF THE DRAWINGS

A control device and method in accordance with the present invention are described in greater detail below on the basis of exemplary embodiments. It should be noted that the figures have only descriptive character and are not intended to limit the present invention in any form.

FIG. 1 shows an exemplary representation of a photovoltaic system having submodules and an associated control circuit.

FIG. 2 shows a submodule having a control circuit in a first exemplary specific embodiment.

FIG. 3 shows a submodule having a control circuit in an additional exemplary specific embodiment.

FIG. 4 shows an exemplary flow chart for carrying out a control of the solar current generation in a submodule.

FIG. 5 shows a representation of an exemplary switching process during the control of the solar current generation in a time diagram.

FIG. 6 shows a representation of an exemplary switching behavior that is a function of the degree of a shadowing.

### DETAILED DESCRIPTION OF EXAMPLE EMBODIMENTS

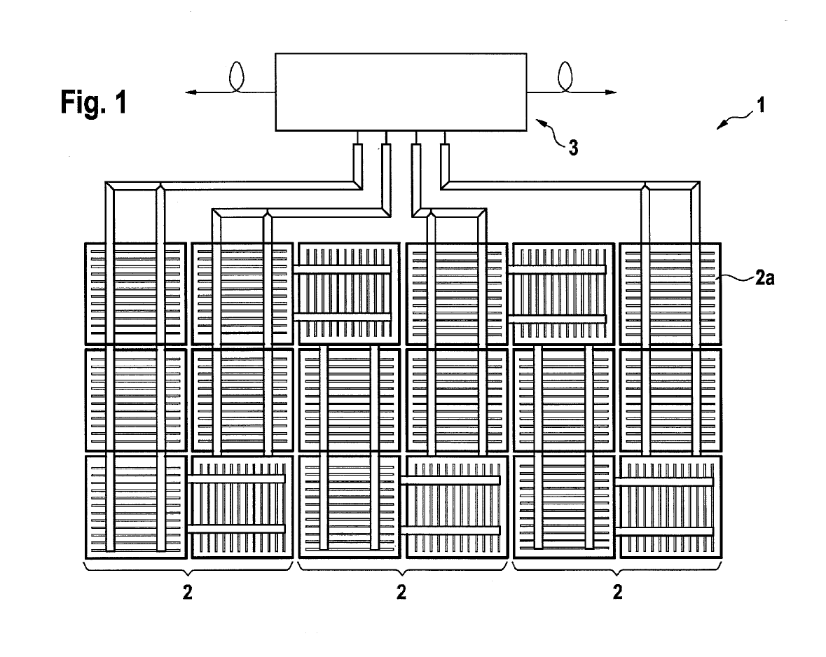

FIG. 1 shows an exemplary photovoltaic system 1. This is made up of a series of submodules 2 interconnected to one another, which are each constructed of individual solar cells 2a. The voltage generated photovoltaically in each of the individual solar cells is added up because of the interconnection. As a result, each individual submodule 2 generates a voltage over the submodule and finally contributes to an overall voltage over the entire photovoltaic system.

The individual submodules in this design function as the smallest functional unit and are controlled by a control circuit 3. The control circuit monitors the current strength of the electric solar current generated by each individual solar module. As soon as, in one or more submodules, the current strength of the solar current drops below a certain value, especially as a result of a shadowing, the corresponding submodules are bridged by the control circuit, so that their inner resistance does not have a negative effect on the entire photovoltaic system.

In the following, an example method of operating of the control circuit is explained with the aid of a system from a submodule and a control circuit for this submodule. In photovoltaic systems constructed of a plurality of submodules, either each individual submodule has its own control circuit associated with it or, depending on expediency, several submodules may be linked to one control circuit.

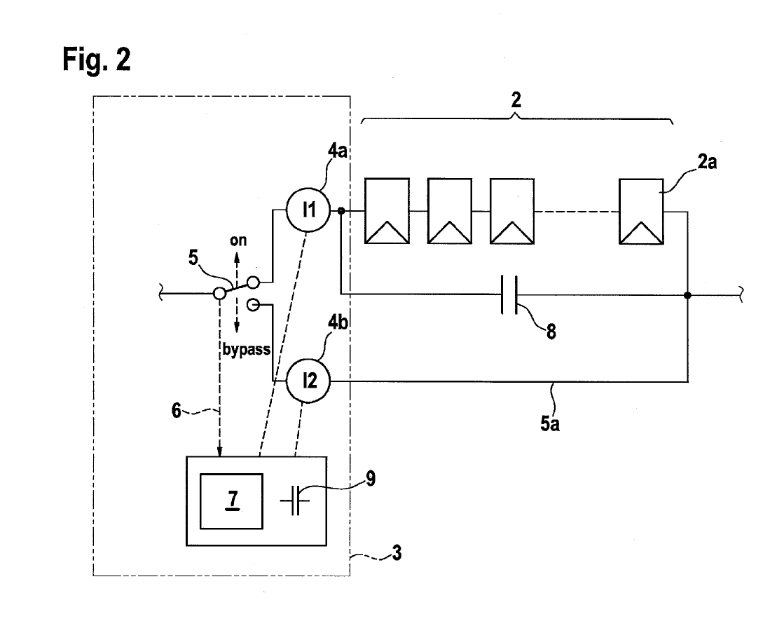

FIG. 2 shows a representation of a circuit diagram of a submodule 2 having a control circuit 3 in a first exemplary specific embodiment. The submodule shown here is made up of an arrangement having a plurality of individual solar cells 2a. The control circuit includes a current measuring device 4 having current measurers 4a and 4b, a change-over switch 5, which is acted upon by a change-over switch pulse 6, and a timer unit 7.

Change-over switch 5 is used for connecting and disconnecting the submodule. It is able to take on a switching-on state or a bypass switching state. In the switching-on state, the submodule is connected to the overall system of the photovoltaic system. The system current flow within the photovoltaic device runs through solar cells 2a of the submodule, in this context, which contribute their part of the solar current. In the bypass switching state the submodule is bridged and is consequently disconnected from the interconnection of the photovoltaic system. In such a case, the overall current flow is conducted via a current path 5a, which bridges the submodule.

The solar current generated by and flowing through this arrangement is detected by current measuring device 4. In the process, during the switching-on state, first current measurer 4a measures a current strength I1 made possible by the submodule, and during the bypass switching state, second current measurer 4b measures a current strength I2 made possible within the overall photovoltaic system. The two values are compared to each other in a sample-and-hold circuit that is not shown here.

Timer unit 7 acts upon change-over switch 5 using a switchover pulse 6. In such a case, the switching state of change-over switch 5 changes from the switching-on state to the bypass switching state and back to the switching-on state. The submodule is thereby either bridged and disconnected from the overall system of the photovoltaic system or is integrated into the circuit of the photovoltaic system.

This shifting procedure is influenced by a capacitor 8. The latter is connected in parallel to submodule 2 and charges up during the operation of the submodule. When the submodule is shadowed, a discharge of capacitor 8 takes place. Current strength I1 registered at current measuring instrument 4a thereby drops off at a time constant conditioned by the discharge current of the capacitor, so that current strength I1 falls below a specified threshold value after a certain delay. Consequently, capacitor 8 has the effect of a delayed change-over switching of change-over switch 5 from the switching-on state into the bypass switching state.

In this instance, the delay of this change-over switching procedure is a function of the charging state of the capacitor and of the performance of submodule 2. In the case of an only brief or weak shadowing of submodule 2, capacitor 8 outputs a discharge current having a relatively large time constant, so that current strength I1 falls below the given threshold value only after a relatively long time period. In such a case, the changeover into the bypass switching state sets in with great delay, or may even not happen at all. Because of that, the only weakly shadowed submodule is not disconnected from the overall circuit, the capacitor acting as a temporary energy store.

In the case of a shadowing, particularly a complete darkening of the submodule, the discharge of the capacitor takes place having a relatively small time constant. The capacitor discharges rapidly, current strength I1 thus drops off correspondingly rapidly below a specified threshold value and the changeover into the bypass switching state thus takes place after a comparatively short time interval. Because of that, the completely darkened submodule, which is now useless for energy production, is rapidly bridged.

Switching back into the switching-on state takes place by a renewed changeover pulse of the timer unit.

For this, the timer unit has a time clock pulsing which, after the changeover of the changeover switch into the bypass switching state, has the effect of a periodic changeover of the changeover switch into the switching-on state. In the exemplary embodiment shown in FIG. 2, a timer capacitor 9 is provided for this. By its discharge, the latter triggers a renewed changeover pulse, and thus an alternating change of changeover switch 5 between the switching-on state and the bypass switching state.

Provided the timer capacitor is fed by the submodule or the photovoltaic system, its trigger function is connected directly to the present energy production of the submodule or to the photovoltaic system. With that, after a time derived from the solar current of the photovoltaic system or from the submodule, the changeover switch is able to be switched over into the respectively other position.

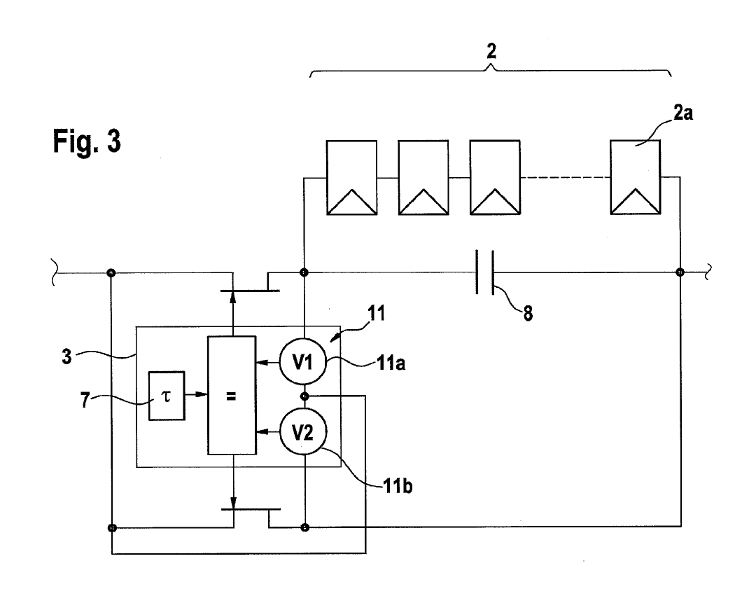

FIG. 3 shows a submodule having a control circuit 3 in an additional exemplary specific embodiment. In the present example, the control circuit is monolithic and executed in an integrated manner. The control circuit has an integrated timer unit 7 for this. To measure current strengths I1 and I2, two switching transistors are provided in the example under discussion. The forward resistance given for each switching transistor, between drain and source is used, in this instance, as instrument shunt 11 for the switching logic. The instrument shunt is made up of two shunts 11a and 11b. Voltages V1 and V2 that are respectively being reduced via the ohmic resistances of the shunts are scanned in the respective switching-on state s and bypass switching states and recalculated into current strength values I1 and 12. In this context, the timer gives the internally specified changeover time and with that, the timing for renewed measurement. In the present example also, the submodule is buffered by capacitor 8, so that, in the manner that was described, a transition of the submodule into the bridged state takes place at the delayed time determined by the discharge of the capacitor.

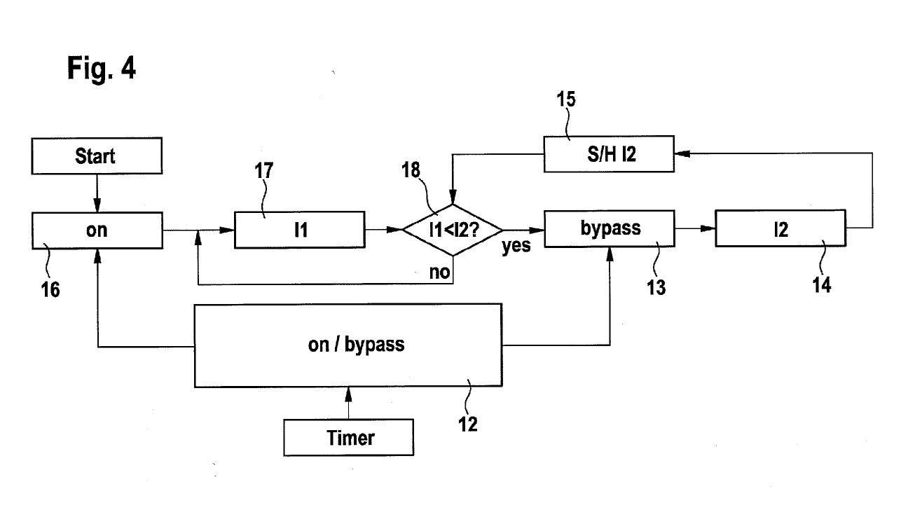

FIG. 4 shows an exemplary flow chart of the control of solar current generation. It includes two loop-shaped method sequences that engage with each other.

A first method sequence relates to a continuous setpoint value implementation in the photovoltaic system. It begins with a reset step 12, in which a changeover signal is output to the changeover switch. The changeover switch is thereupon switched to the bypass switching state in a switching step 13. Next, the value for system current I2 is measured in a step 14 and is stored in a sample-and-hold (S/H) step of the control circuit in a step 15. The sample-and-hold step may be developed in the form of an internal memory or, for instance, as an analog voltage via an integrated capacitance.

A second method sequence is formed by the continuous measurement of current strength I1 generated by the submodule and a continual comparison of the value determined in the process to the value for system current I2 stored in the sample-and-hold step. For this, there takes place a switching action 16, in which the changeover switch is changed over to the switching-on state. After that, current strength I1, generated by the submodule, is measured. At the same time it is checked whether current strength I1 has fallen below a threshold value oriented to it by the value I2 or a corresponding one.

In the process, the timer unit generates, in a fixed changeover clock pulse T, an alternating switching between the switching-on state and the bypass switching state, so that the two method sequences mentioned are carried out in an alternating manner. This alternating switching is expediently designed in such a way that a set pulse switches the changeover switch into the bypass switching state, and a subsequent reset pulse sets the changeover switch back into the on-switching position, so that, after the reset pulse, the changeover switch is always in the on-switching position.

In this context, the switching-on state may be interrupted at any time. This is the case as soon as a decision step 18, that is linked to measuring step 17, signals that current strength I1 drops off below the setpoint value set by value I2 or oriented to the value I2. The changeover switch is switched to the bypass switching state, in this instance, by a renewed carrying out of step 13, and the submodule is separated from the circuit. The submodule then operates self-sufficiently and charges capacitor 8 again by the solar energy that continues to be generated in the submodule.

This bypass switching state is ended at the latest when the timer unit outputs a renewed changeover pulse to the changeover switch, so that reset step 12, and as a result thereof, method steps 16, 17 and 18 are run through again.

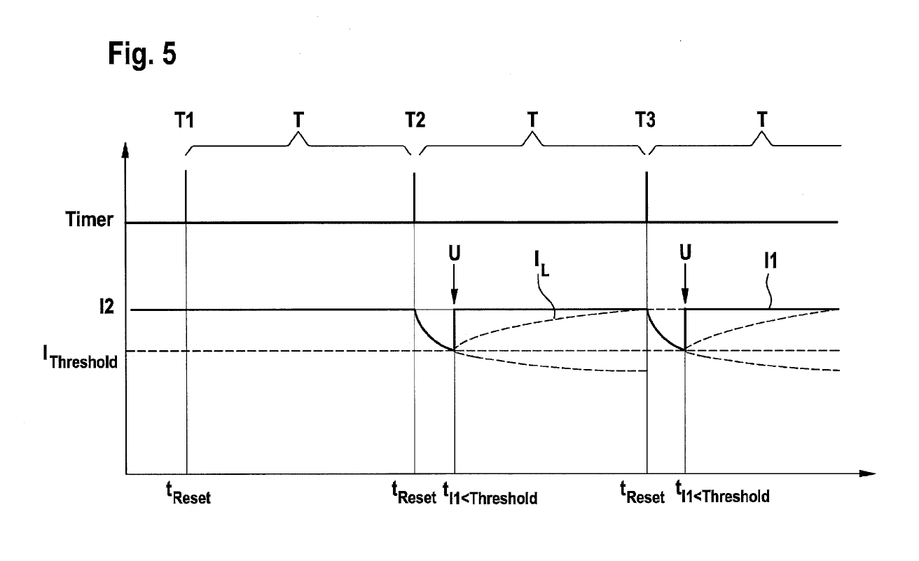

FIG. 5 shows a representation of an exemplary switching process during the control of the solar current generation, in a time diagram. For one thing, the diagram includes a representation of the sequence of changeover pulses T1, T2 and T3 that are output by timer unit 7. These follow one another within a switchover clock pulse T. This illustrates the curve over time of current strength I1.

During first changeover pulse T1, current I1 corresponds to system current I2. At time T2 of the second reset pulse, a shadowing occurs, which reduces the current of the submodule to 70%, for example, of the system current. In this context, current I1, at time t_{I1<Threshold}, falls below a threshold value given here of I_{Threshold} of 80% of current I2. This falling below triggers a switchover pulse U. As of this time, the submodule is bridged. The solar current generation, continuing to take place in the submodule, charges capacitor 8 again along dashed line I_{L}. At the time of the third reset pulse T3, the changeover switch is set again to the switching-on state, and the capacitor discharges again. Since, in the case present here, the shadowing of the submodule has not yet been overcome, a renewed switchover pulse U is triggered, and the process described is repeated. In this context, current is being continuously generated in the bridged submodule, is collected in the capacitor, and is output to the system after times T1 and T2.

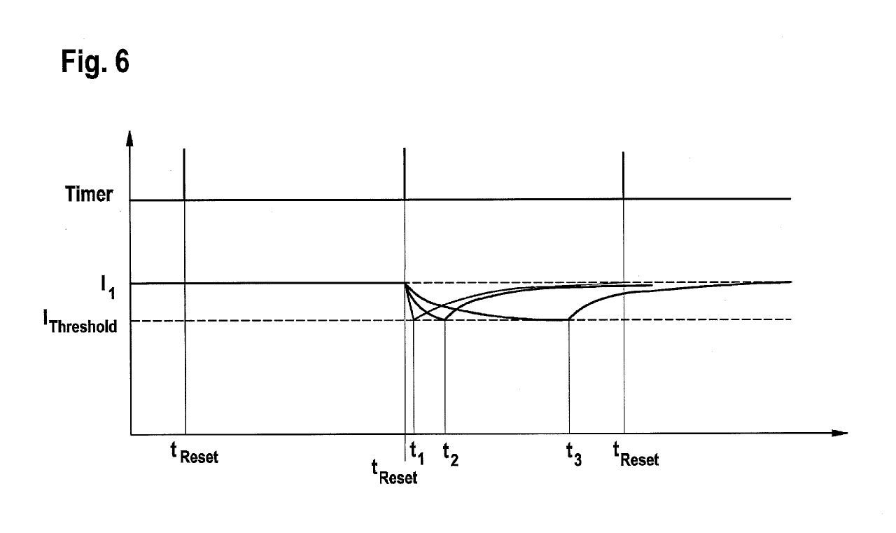

With the aid of a diagram, FIG. 6 shows a representation of an exemplary switching behavior that is a function of the degree of the shadowing. If the solar energy generated by the submodule is clearly less than that of the overall system, which is the case in response to great shadowing, submodule current I1 very rapidly falls below the value I_{Threshold} defined by system current I2, and the changeover switch switches to the bypass switching state already at time t₁. If, by contrast, there is only weak shadowing, the capacitor discharges more slowly because of the higher final value, so that the switch clearly switches over to the bypass switching state later, at a time t₂ or t₃. The submodule thereby makes a considerable contribution to the overall energy gain.

The time control of the timer unit, i.e., time clock pulse T, may also be varied, however, and have feedback to the operation of the submodule. In this context, timing clock pulse T, that was fixed, is varied, so that the reset pulses follow more quickly or more slowly upon one another. This time control is advantageously specified by the submodule itself, and is set so that the time control shifts to shorter times, with increasing shadowing, that is, as a function of the dropping off of current I1.

This example embodiment offers the advantage that the submodules, connected in series in the overall system, and having the respectively associated switching devices, do not influence one another mutually over more than one switching cycle. This means that the probability that two or more switching devices go over simultaneously into the bypass switching state, and thereby theoretically, in the extreme case, all the submodules could be bridged, is negligible.

A further advantage is that, at low solar irradiation, the cell capacity also becomes less within the meaning of an inherent capacitor of the submodule, and with that, at solar currents that are becoming smaller, the capacitors are able to be discharged and also recharged more rapidly.

One additional embodiment is the utilization of the inherent capacitance of solar cells 2a. This capacitance, also known as diode capacitance, of the pn-junction is a function of illumination, and, in the case of high-power solar cells of 240 cm² area, may achieve values of up to 10 μF in the non-illuminated case and 1000 μF at full illumination (1000 W/m². Since this capacitance is in each case connected in parallel to the current source representing the solar cell, approximately the overall capacitance of the substrings may be set in the same order of magnitude. With that, in one advantageous specific embodiment, one may do without a separate external capacitor as shown, for example, in FIG. 2.

For the optimization of the efficiency, it basically applies that the changeover pulse, and thus the measuring of the respectively other comparison current, should be used only for an extremely short time. This is clear, since in the case of the non-shadowed submodule the measurement (and with that, the short circuit of the submodule) narrows the achievable yield. However, if one assumes a measuring time of 100 μs for this changeover (in the case of extremely highly set capacitor size of 1000 μF at full irradiation and R_{DSun} of 100 mOhm) and a hold time (time to the next reset) of 1 s at full irradiation, one obtains an efficiency loss of 100 ppm or 0.01%. For this, however, the loss has to be added via the measuring shunt shown in FIG. 3. At a nominal current of 8 A, 800 mW drop off over an energy switch, and in response to an equipment of three energy switches per module having a nominal performance of 240 W, a power loss therefore comes about of 3×24 mW=72 mW by the reset pulse and 3×800 mW=2.4 W by the power transistors connected in series, thus, altogether about 3 W per solar module.

At lower solar irradiation the cell capacitances decrease by approximately a factor of 100, so that about 10 μF cell capacitance would be expected in response to a 156 mm solar cell. With that, the measuring time becomes reduced to 1 μs. Based on the reset intervals, which are then, however, more meaningfully shorter, the efficiency loss is also displaced. A meaningful assumption could be 1 ms in this case, so that in the non-shadowed operation, an efficiency of 99.9% could still be achieved, less proportionally smaller losses by the power transistors of about 1%, in turn.

That is, by using the device described here as well as by carrying out the method, one loses approximately 1% of the solar current in the non-shadowing state. However, this is countered by a proportional gain in the shadowing case. The switching technology effort required for this is clearly below the conventional module-based MPP tracker having an integrated DC/DC converter.

For the power estimate, one may assume, for instance, a power transistor (FET), which, in response to a maximum feedthrough current of 16 A and a maximum switching voltage of 16 A has an ohmic resistance between drain and source R_{DSun} of 100 mOhm. An optimization of this closing resistor, for instance, to 10 mOhm reduces the power loss, in this example, by barely 0.32 Watt, and thus clearly less than 0.2%. In other words, the method shown here ensures an efficiency of 99.8% in comparison with the power of a non-shadowed module. This slight forfeit of efficiency is countered, however, by an effective power yield of the submodule in the shadowing case.

By using a communications interface which compulsorily transfers the changeover switch to the bypass switching state, the submodule and accordingly the entire photovoltaic system is able to be switched currentless and even to short circuit of the module. Such a switching position is designated as “disabled” below. This may be meaningful if, for example, during a module exchange, that has become necessary, the submodule has to be separated during the day or, for example, in case of fire, the system has to be switched currentless, in order, for instance, to open a roof for fighting the fire.

One possible approach of the communication, in this instance, may be a separate control line, which is connected to all the submodules. Similarly, powerline concepts could be used in which signals are sent over the solar current lines, or wireless approaches over conventional high frequency communications protocols (Zigbee, WLAN, etc). If powerline concepts are used, for example, the presence of an “enable” signal may be required necessarily for the normal operating method of the module shown in FIG. 3. In this context, an intact solar current line is required for the transmission of this enable signal. If an electric arc is created in the fault case, the fault spectra appearing in the process disturb this enable signal in such a way that the communications component no longer detects this signal, and switches to the “disable” mode. This would also offer an arc detection and an automatic extinction by switching down the voltage in the circuit (by “switching out” the submodules) until the point of extinction of the arc.

Additional developments and implementations of the exemplarily described method and device are yielded that are within the scope of the actions of one skilled in the art.

1-14. (canceled)

15. A method for controlling current generation in a photovoltaic system having at least one submodule connected into the photovoltaic system, comprising:
switching of the submodule at a switchover time clock pulse alternately between a switching-on state and a bypass switching state, the submodule being interconnected during the switching-on state of the photovoltaic system and being bridged in the bypass switching state;
during the bypass switching state, measuring an overall current strength of the photovoltaic system, and ascertaining a setpoint value from the overall current strength, and temporarily storing the ascertained set point value, and, during the switching-on state, measuring a submodule current strength and comparing the submodule current strength to the setpoint value; and
resetting the submodule into the bypass switching state independently of the switchover time clock pulse in response to a drop in the submodule current strength below the setpoint value.

16. The method as recited in claim 15, wherein the resetting is carried out at a switching time which is a function of a magnitude of a deviation between the setpoint value and the submodule current strength.

17. The method as recited in claim 15, wherein the switching time of the resetting is influenced by a discharge behavior of a capacitor connected to the submodule.

18. The method as recited in claim 15, wherein switching time of the resetting is influenced by a discharge behavior of at least one inherent illumination-dependent capacitance of a solar cell of the submodule.

19. The method as recited in claim 15, wherein the switchover time clock pulse has a value that is a function of the submodule current strength.

20. The method as recited in claim 15, wherein the switchover time clock pulse is able to be set externally at will via an interface.

21. A device for controlling current generation in a photovoltaic system having at least one submodule connected to the photovoltaic system, the device comprising:
a control circuit having a first current measuring device to measure a strength of a current generated by the submodule, a second current measuring device to measure a strength of a current generated in the photovoltaic system, a changeover switch to set the submodule alternately to a switching-on state or a bypass switching state, and a timer unit that sets the changeover switch.

22. The device as recited in claim 21, wherein the submodule has an energy store in a form of a capacitor that is connected in parallel.

23. The device as recited in claim 21, wherein the submodule has an energy store in a form of an inherent diode capacitance of the solar cells.

24. The device as recited in claim 21, wherein the timer unit has a timer capacitor that is fed by at least one of the submodule and the photovoltaic system.

25. The device as recited in claim 21, wherein the current measuring device includes a system of switching transistors that is situated in a measuring shunt.

26. The device as recited in claim 21, wherein the control circuit has an interface for carrying out a forced switching of the submodule to a switching-on state or a bypass switching state.

27. The device as recited in claim 26, wherein the interface is connected to a communications unit for the forced switching which, in the case of at least one of danger and of maintenance, transfers the at least one submodule to the bypass switching state.

28. The device as recited in claim 26, wherein, for a transport, the at least one submodule is able to be transferred to the bypass switching state for the forced switching via the interface.
